(19) United States
(12) Patent Application Publication
(10) Pub. No.: US 2026/0309867 A1
(43) Pub. Date: Oct. 8, 2026

(54) SYSTEM AND METHOD FOR TRACKING POSES OF PLURALITY OF DEVICES WITHIN AN ENVIRONMENT

(71) Applicant: Varjo Technologies Oy, Helsinki (FI)

(72) Inventors: Ville Timonen, Helsinki (FI); Kai Inha, Järvenpää (FI); Mika-Petteri Lundgren, Salo (FI); Oliver Merilaid, Helsinki (FI)

(73) Assignee: Varjo Technologies Oy, Helsinki (FI)

(21) Appl. No.: 19/171,778

(22) Filed: Apr. 7, 2025

(51) Int. Cl. G01S 15/08; G01S 7/52

(52) U.S. Cl. CPC G01S 15/08; G01S 7/52006

(57) ABSTRACT

A system for tracking poses of devices within an environment, system including: audio sensors, wherein audio sensor(s) is attached with each device amongst devices, each audio sensor is configured to: detect sound signals incident thereon; and generate sensor data including timestamps corresponding to detected sound signals; and a processor communicatively coupled to audio sensors. The processor is configured to: receive sensor data from audio sensors; identify acoustic events based on correlations of detected sound signals across sensor data; estimate relative poses of devices based on time differences of arrival (TDoA) of sound signals corresponding to a same acoustic event and speed of sound in environment; and determine poses of devices within coordinate space of environment, based on estimated relative poses of devices, speed of sound, and pose of source(s) of sound signals in coordinate space.

### TECHNICAL FIELD

The present disclosure relates to systems and methods for tracking poses of plurality of devices within environments. The present disclosure relates to the technical field of spatial tracking of a plurality of devices within an environment. More particularly, the present disclosure relates to systems and methods for pose estimation based on sound signal detection and localization.

### BACKGROUND

Tracking position and orientation of devices (such as a head-mounted display device, a user-interaction controller, a wearable device, and similar) in a given space is an essential aspect of numerous modern applications, including virtual reality (VR), augmented reality (AR), gaming, robotics, industrial automation, and similar. The ability to determine spatial location and orientation of said devices relative to their environment enables for enhanced interaction between users and systems, enabling immersive experiences and precise control. However, achieving highly accurate, real-time spatial tracking of said devices remains a technical challenge, particularly in dynamic environments where factors for example, such as a visual noise, an occlusion, an interference, and similar, can disrupt signal detection and processing.

Conventionally, several existing tracking systems have relied on methods that combine sensor fusion technologies, for example, such as Inertial Measurement Units (IMUs), visual camera sensors, and similar. In this regard, while IMUs provide motion data, they are prone to drift over time and require periodic correction through global localization techniques, such as visual Simultaneous Localization and Mapping (SLAM). Typically, visual SLAM systems use cameras to identify and track distinguishable features in an environment, enabling precise tracking of a position and an orientation of said devices. However, despite their effectiveness in controlled scenarios, said systems face significant limitations in real-world applications.

Firstly, the visual SLAM systems struggle in low-light conditions where reliable, noise-free features are difficult to detect. For example, in dimly lit environments or areas with insufficient illumination, a lack of distinguishable visual markers can hinder ability of the visual SLAM systems to maintain accurate tracking of said devices. Secondly, in featureless environments, for example, such as those environments dominated by green screens, flat screens, texture less walls, and similar, the visual SLAM systems fails to identify sufficient visual reference points to maintain reliable tracking of said devices. Thirdly, cameras often fail to track said devices when they are pointed towards flat surfaces, such as walls or areas beneath tables, where no discernible edges or patterns are present. Fourthly, when light-emitting diode (LED) constellation-tracked devices move outside the camera's field of view, the visual SLAM systems loses ability to track said devices, thereby limiting its reliability in dynamic, real-world conditions.

Therefore, in light of the foregoing discussion, there is a need to overcome the aforementioned limitations to enhance the accuracy and robustness of pose tracking for a plurality of devices in dynamic environments.

### SUMMARY

The aim of the present disclosure is to provide a system and a method to enable accurate and real-time tracking of poses of a plurality of devices within an environment using acoustic signals. The aim of the disclosure is achieved by a system and a method for tracking poses of a plurality of devices within an environment to accurately determine their spatial positions and orientations based on detected sound signals, leveraging time differences of arrival (TDoA) and other acoustic signal properties to enable precise localization, navigation, and spatial awareness for various applications. The aim of the present disclosure is achieved by a system and a method for tracking poses of a plurality of devices within an environment, as defined in the appended independent claims to which reference is made to. Advantageous features are set out in the appended dependent claims. The embodiments of the present disclosure substantially enable to improve the spatial accuracy, robustness, and environmental adaptability of pose tracking by leveraging time differences of arrival (TDoA) of sound signals detected by a plurality of audio sensors. Additional aspects, advantages, features and objects of the present disclosure would be made apparent from the drawings and the detailed description of the illustrative embodiments constructed in conjunction with the appended claims that follow.

In the embodiments, each device amongst the plurality of devices comprises at least one audio sensor configured to detect sound signals and generate timestamped sensor data. A processor communicably coupled to the audio sensors is configured to identify acoustic events, estimate relative positions of the devices based on TDoA measurements, and in some embodiments, determine full poses by further utilizing DOA computations. Optionally, the system comprises a temperature sensor for calibrating the speed of sound in varying environmental conditions to improve localization accuracy. In certain embodiments, the direction of arrival (DOA) of sound signals is computed to enhance pose estimation. Moreover, the processor may determine distances between devices using TDoA when the sound source lies within an area defined by the devices, and using a combination of TDoA and DOA when the sound source lies outside the area. The system may also incorporate data from inertial measurement units (IMUs) and visual cameras to improve tracking fidelity. Time synchronization between devices is optionally maintained using a shared time reference, enhancing inter-device correlation. The system can track devices such as head-mounted displays, controllers, wearables, and tracking pucks across virtual, augmented, or industrial environments.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates an exemplary schematic illustration of an environment where a system for tracking poses of a plurality of devices is used, in accordance with an embodiment of the present disclosure;

FIG. 2 illustrates a block diagram of a system for tracking poses of a plurality of devices within an environment, in accordance with an embodiment of the present disclosure; and

FIG. 3 illustrates steps of a method for tracking poses of a plurality of devices within an environment, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a system for tracking poses of a plurality of devices within an environment, the system comprising:
a plurality of audio sensors, wherein at least one audio sensor is attached with each device amongst the plurality of devices, wherein each audio sensor is configured to:
   detect sound signals incident thereon; and
   generate sensor data including timestamps corresponding to the detected sound signals; and
a processor communicatively coupled to the plurality of audio sensors, wherein the processor is configured to:
   receive the sensor data from the plurality of audio sensors;
   identify one or more acoustic events based on correlations of the detected sound signals across the sensor data;
   estimate relative poses of the plurality of devices based on time differences of arrival (TDoA) of the sound signals corresponding to a same acoustic event and a speed of sound in the environment; and
   determine poses of the plurality of devices within a coordinate space of the environment, based on the estimated relative poses of the plurality of devices, the speed of sound, and a pose of at least one source of the sound signals in the coordinate space.

In a second aspect, the present disclosure provides a method for tracking poses of a plurality of devices within an environment, the method comprising:
detecting sound signals incident on a plurality of audio sensors and generating sensor data including timestamps corresponding to the detected sound signals, wherein at least one audio sensor is attached with each device amongst the plurality of devices;
receiving the sensor data from the plurality of audio sensors; identifying one or more acoustic events based on correlations of detected sound signals across the sensor data;
estimating relative poses of the plurality of devices based on time differences of arrival (TDoA) of the sound signals corresponding to a same acoustic event and a speed of sound in the environment; and
determining poses of the plurality of devices within a coordinate space of the environment, based on the estimated relative poses of the plurality of devices, the speed of sound, and a pose of at least one source of the sound signals in the coordinate space.

The present disclosure provides the aforementioned first aspect and the aforementioned second aspect for tracking poses of the plurality of devices within the environment. It will be appreciated that by utilizing the plurality of audio sensors detects the sound signals and generates timestamped sensor data, allowing for an identification of the one or more acoustic events. Beneficially, the processor being communicatively coupled to the plurality of audio sensors, processes the sensor data to estimate the relative poses of the plurality of devices based on the time differences of arrival (TDoA) of the sound signals. Such an estimation provides a robust method for determining poses of the plurality of devices within the coordinate space without requiring external tracking infrastructure such as cameras, radio-based localization systems, and similar. Moreover, the system can dynamically adapt to different environments by calibrating the speed of a sound based on environmental conditions, such as temperature variations, thereby improving localization accuracy.

Furthermore, by leveraging correlations between the detected sound signals across the plurality of audio sensors, the system enables precise identification of the one or more acoustic events. Such an approach allows for the estimation of relative poses of the plurality of devices using TDoA measurements and environmental parameters, thereby ensuring a robust and adaptable localization framework. Unlike traditional tracking methods that rely on visual or electromagnetic signals, the aforesaid method offers enhanced performance in environments with limited visibility or radio frequency interference. Beneficially, the method can be implemented for a variety of devices, including head-mounted displays, controllers, wearable devices, and similar, providing a flexible and scalable tracking solution. By incorporating sound-based localization techniques, the method allows for seamless integration with other tracking modalities, such as inertial measurement units (IMUs) and visual cameras, further enhancing accuracy and robustness of pose estimation of the plurality of devices. The system and the method are fast, robust, easy to implement, and facilitate accurate and real-time tracking of the plurality of devices within the environment.

Throughout the present disclosure, the term “device” refers to an electronic device or a computational unit equipped with the at least one audio sensor that is capable of detecting the sound signals within the environment. The term “environment” refers to a given space in which the plurality of devices operate and are being tracked by the system. The environment may be an indoor or an outdoor space and can include controlled environments such as virtual reality (VR), augmented reality (AR) setups, industrial facilities, and similar. In some implementations, the system may comprise the plurality of devices.

Optionally, the plurality of devices comprise at least two of: a head-mounted display device, a user-interaction controller, a tracking puck, a wearable device. In this regard, the term “head-mounted display device” refers to a specialized equipment that is configured to present an extended reality (XR) environment to a user when said HMD, in operation, is worn by the user on their head. The head-mounted display (HMD) device is implemented, for example, as an XR headset, a pair of XR glasses, and the like, that is operable to display a visual scene of the XR environment to the user. It will be appreciated that when the device is the HMD, it enables immersive user experiences by directly engaging in the user's field of view, allowing for seamless integration of virtual or augmented content with the physical world, improving interaction and immersion of the user. Moreover, the term “user-interaction controller” refers to a handheld or a body-worn input device designed to facilitate interaction with a computing system, within the VR, the AR, or gaming environment. The user-interaction controller may include buttons, triggers, touchpads, joysticks, haptic feedback mechanisms, motion sensors, and similar, to capture user inputs. The user-interaction device can communicate wirelessly or via a wired connection with the system to enable gesture-based controls, motion tracking, and tactile feedback. Moreover, the term “tracking puck” refers to a compact, an attachable electronic device designed to enable spatial tracking of non-standard objects within a virtual or augmented reality system. The tracking puck is equipped with the at least one audio sensor that allow the system to determine its position and orientation within the environment. The tracking puck can be mounted on physical objects, such as props, tools, or user limbs, to facilitate real-time tracking and interaction within a virtual environment. Moreover, the term “wearable device” refers to an electronic device designed to be worn on a body of a given user, to facilitate motion tracking, biometric sensing, or user interaction within an immersive computing environment. Examples of the wearable device may include, but are not limited to, a smart glove, a wristband, a sensor-equipped clothing, and a motion-capture suit. The wearable is equipped with the at least one audio sensor that allows the system to determine its position and orientation within the environment. The all aforesaid types of the plurality of devices are well-known in the art.

A technical effect of the plurality of devices comprising at least two of: the head-mounted display device, the user-interaction controller, the tracking puck, the wearable device is that the system enables multi-device spatial tracking, allowing for accurate, real-time determination of relative and absolute poses of different devices within the environment. It will be appreciated that by incorporating multiple types of device, the system can improve localization accuracy, enhance user interaction, and provide a more immersive experience in VR, AR, or MR applications. Additionally, the integration of diverse devices facilitates flexible tracking configurations, ensuring adaptability across different use cases, such as full-body motion capture, precise hand-tracking, object-based interaction, and similar.

Throughout the present disclosure, the term “audio sensor” refers to a device capable of detecting and capturing sound waves within the environment and converting them into electrical signals for further processing. Examples of the at least one audio sensor may include, but are not limited to, a microphone, and an ultrasonic microphone. The term “sound signal” refers to a propagating acoustic wave that travels through a medium (e.g., air, and similar) and is characterized by variations in pressure over time. The sound signal may be generated by an external source, an event occurring in the environment, or an active emission from a given device for tracking purposes. The sound signal has key parameters such as a frequency, an amplitude, a phase, and a propagation speed, which influence how it is detected and processed by the plurality of audio sensors. The term “sensor data” refers to an electronic data or a digital data generated by the at least one audio sensor based on the detected sound signals. The sensor data includes timestamps indicating precise moments when the sound signals are received and may further include an amplitude, frequency characteristics, a phase information, a signal intensity, and similar. Such data is utilized by the processor for correlation, time difference of arrival (TDoA) calculations, and pose estimation of the plurality of devices in the environment.

In an implementation, the at least one audio sensor is attached with each device amongst the plurality of devices to detect incident sound signals and generate corresponding timestamped sensor data for pose estimation. In other words, the at least one audio sensor is a part of a given device amongst the plurality of devices. In this regard, each audio sensor passively detects the sound signals that are emitted from at least one source (described later) or generated by an event in the environment. The detected sound signals can include naturally occurring sounds, specifically generated acoustic signals intended for localization, and similar. When a sound signal is detected, the at least one audio sensor records a precise timestamp indicating when said sound signal was received. Such an approach allows for calculating the TDoA across the plurality of devices. The sensor data being recorded by the at least one audio sensor, including timestamps, is sent to the processor that correlates said sensor data across the plurality of devices to determine their relative positions. It will be appreciated that by arranging the at least one audio sensor across the plurality of devices, the system can accurately determine relative and absolute poses of the plurality of devices within the environment without reliance on external tracking systems.

Optionally, a given audio sensor is configured to detect ultrasonic signals emitted by an ultrasonic beacon operating at predefined intervals. In this regard, the term “ultrasonic beacon” refers to a device configured to emit the ultrasonic signals, which are sound waves with frequencies above human hearing range (i.e., above 20 kilohertz). The ultrasonic beacon generates and transmits these signals at predefined intervals for detection by the given sensor within the system. Moreover, the term “predefined interval” refers to a specific duration of time that is fixed, configurable, or dynamically adjusted based on requirements of the system, during which a particular event, an operation, or a signal transmission occurs. In the context of an audio-based tracking system, the predefined interval defines a time spacing between successive emissions of the ultrasonic signals. The predefined interval may be determined based on factors such as, system timing constraints (i.e., ensuring synchronization between the plurality of devices), desired localization accuracy (i.e., optimizing a frequency of signal emissions), environmental conditions (like acoustic reflections or interference), power efficiency requirements (i.e., minimizing unnecessary signal transmissions), and similar. The predefined interval may be fixed (i.e., where the interval remains constant over time), adaptive (i.e., where the interval is adjusted dynamically based on system feedback, environmental conditions, or detected device movement), application-specific (i.e., where different intervals are used for different tracking modes such as high-frequency updates for fast motion tracking, lower-frequency updates for power-saving modes, and similar). Notably, the at least one audio sensor comprises the given audio sensor.

It will be appreciated that by utilizing the ultrasonic beacon, the system benefits from high-precision localization, reduced sensitivity to environmental noise, and robust tracking performance, particularly in environments where visual or radio-based tracking methods may be unreliable. It will also be appreciated that the predefined interval ensures synchronization between the ultrasonic signal emissions and detections across the plurality of devices, thereby minimizing timing errors and improving overall consistency of localization data. A technical effect of the given audio sensor configured to detect the ultrasonic signals emitted by the ultrasonic beacon operating at the predefined intervals is that it enables precise and real-time localization of the plurality of devices.

Optionally, a given audio sensor is selected from at least one of: a microphone array, an acoustic camera. In this regard, the term “microphone” refers to an electronic device designed to capture sound waves from the environment and convert them into electrical signals. The microphone array comprises multiple spatially distributed microphones that work collectively to capture the sound signals from various directions within the environment. It will be appreciated that the microphone array allows for real-time capture of the sound signals, thereby enhancing ability of the system to accurately determine the direction and origin of the at least one sound source within the environment. By leveraging spatial filtering and beamforming techniques, the microphone array improves signal-to-noise ratio, reducing interference from unwanted background noise. This enhances capability of the system to distinguish between multiple acoustic events, facilitating more precise TDoA measurements for pose estimation of the plurality of devices. Such an approach also enables more immersive user experiences, such as spatial audio feedback, voice recognition, interaction with virtual objects via sound, and similar. Moreover, the term “acoustic camera” refers to a device that integrates an array of microphones with signal processing algorithms to capture, visualize, and localize sound sources within the environment. The acoustic camera is used for tasks such as identifying noise sources, sound field visualization, and detailed acoustic analysis in environments like industrial plants, automotive testing, architectural acoustics, and similar. It will be appreciated that the use of the acoustic camera provides detailed sound localization, which improves ability of the system to track dynamic sound sources and interactions. This enhances realism and interactivity of the XR environment by offering precise audio feedback that aligns with visual elements, thereby enabling precise user interactions and improving response of the virtual environment to real-time audio inputs. Additionally, the acoustic camera allows for real-time spatial mapping of the at least one sound source, facilitating more effective tracking of the plurality of devices without relying on external visual or radio-based localization system. The principle operation of the aforesaid types of the given audio sensor is well-known in the art.

A technical effect of the given audio sensor comprising at least one of: the microphone array, the acoustic camera, is that it enhances ability of the system to accurately capture and process the sound signals by providing versatile audio sensing capabilities. The microphone array offers a straightforward means of capturing sound characteristics, while the acoustic camera enables precise localization and visualization of sound sources, thereby improving an accuracy and quality of the sensor data enabling effective rendering of an acoustic environment.

Throughout the present disclosure, the term “processor” refers to a computational element that is operable to execute the software framework. Examples of the processor may include, but are not limited to, a microprocessor, a microcontroller, a complex instruction set computing (CISC) microprocessor, a reduced instruction set computing (RISC) microprocessor, a very long instruction word (VLIW) microprocessor, or any other type of processing circuit. Notably, the processor is communicably coupled to the plurality of audio sensors.

Herein, the processor is configured to receive the sensor data from the plurality of audio sensors via a wired communication interface and/or wireless communication interface, ensuring real-time data acquisition. Each audio sensor detects incident sound signals and generates corresponding sensor data, including timestamps, signal characteristics such as the amplitude, the frequency, the phase, and similar. The sensor data is then transmitted to the processor, which synchronizes and aggregates the received data from the plurality of audio sensors. It will be appreciated that receiving the sensor data from the plurality of audio sensors enables the processor to accurately correlate the detected sound signals across the plurality of devices, enabling precise localization and pose estimation of said devices within the environment. Such an approach facilitates real-time tracking of the plurality of devices without reliance on external tracking systems, thereby enhances robustness of the system against environmental noise, and improves spatial awareness for applications such as AR, VR, indoor navigation, and similar.

Next, the processor is configured to identify the one or more acoustic events by analysing correlations among the detected sound signals across the sensor data received from the plurality of audio sensors. Herein, the term “acoustic event” refers to an occurrence that generates a distinguishable sound signal within the environment, which can be detected and analysed by the plurality of audio sensors. The one or more acoustic events may result from natural sources (e.g., speech, footsteps, object impacts, and the like), artificial sources (e.g., generated ultrasonic pulses, electronic beeps, and the like), and similar. The one or more acoustic events are characterized by properties such as an amplitude, a frequency, a duration, and a temporal pattern, which enable its identification and classification based on correlations across the sensor data. Herein, the processor may apply signal processing techniques such as cross-correlation, TDoA analysis, and frequency-domain analysis to determine the spatial and temporal relationships between the detected sound signals. The processor first synchronizes the received sensor data using timestamps, then compares signal characteristics across different audio sensors to detect matching patterns indicative of the one or more acoustic events. By evaluating consistency and propagation characteristics of the detected signals, the processor determines whether the one or more acoustic events has occurred, its type, and its location within the environment. This enables an accurate tracking, localization, and interaction capabilities within the system. A technical effect of identifying the one or more acoustic events based on correlations of the detected sound signals is that the processor can achieve accurate real-time tracking of the plurality of devices without requiring an external tracking hardware. Such an approach enhances precision in pose estimation, improves interaction efficiency in AR/VR applications, enables context-aware responses, and provides robustness against environmental noise by leveraging multi-sensor data fusion.

Throughout the present disclosure, the phrase “time differences of arrival” refers to differences in a time at which a given sound signal is detected by the plurality of audio sensors that are arranged across the plurality of devices. Further, the processor is configured to estimate the relative poses of the plurality of devices by analysing the TDoA of sound signals corresponding to the same acoustic event across the plurality of audio sensors. When an acoustic event occurs, the emitted sound signal propagates through the environment at a known speed of sound. Due to varying distances between an event source and each device, the sound signal reaches the plurality of audio sensors at slightly different times. In this regard, the processor receives timestamped sensor data from the plurality of audio sensors and calculates the TDoA by determining a time delay between detections of the same sound signal across the plurality of audio sensors. Using these time differences, along with the known speed of the sound in the environment, the processor may apply a triangulation technique or a multilateration technique to estimate relative location of the plurality of devices. By continuously analysing the one or more acoustic events, the processor can further refine and track the dynamic poses of the plurality of devices in real time. A technical effect of such an approach is that the processor accurately track relative poses of the plurality of devices without external tracking hardware, using only the sound signals and the TDoA analysis. This enables precise spatial awareness for applications such as AR, VR, indoor navigation, and motion tracking in environments where traditional optical tracking may be impractical.

Throughout the present disclosure, the term “coordinate space” refers to a mathematical representation of an environment in which positions and orientations of the plurality of devices are defined relative to a reference frame. The coordinate space is structured as a cartesian coordinate system, for example, a two-dimensional (2D) or a three-dimensional (3D), where each point is uniquely identified by a set of numerical values (i.e., x, y, z in 3D space). The coordinate space is fundamental for tracking, navigation, and spatial computation in applications such as robotics, AR, and indoor positioning systems. The term “pose” refers to the full spatial state of a given device, encompassing both its position (i.e., coordinates such as x, y, z in the coordinate space) and its orientation (i.e., angular alignment such as roll, pitch, and yaw). Pose tracking thus provides a more comprehensive representation of a device's spatial configuration compared to positional tracking, which includes only the position without orientation. For example, in a 2D coordinate space, a pose is defined by (x, y) coordinates and an orientation angle (θ). Moreover, in a 3D coordinate space, a pose is defined by (x, y, z) coordinates and orientation angles (i.e., a roll, a pitch, a yaw), which describe rotations around each spatial axis. The pose enables precise localization and movement tracking of the plurality of devices relative to its surroundings, making it essential in fields such as robotics, computer vision, spatial computing, and similar.

Herein, the processor is configured to determine the poses of the plurality of devices within the coordinate space by integrating multiple sources of spatial information. The processor receives relative pose estimates of the plurality of devices from previous calculations based on the TDoA of sound signals. The processor also has information about the speed of sound in the environment. The processor retrieves absolute pose (i.e., a position and an orientation) of the at least one known sound source, such as the ultrasonic beacon, and similar. In this regard, the processor aligns relative poses of the plurality of devices with known absolute pose of the at least one sound source using coordinate transformation techniques. By applying the triangulation technique or the multilateration technique, the processor converts relative poses into absolute positions within the coordinate space. If multiple sound sources are present, the processor may use multiple reference points for increased accuracy. Then, the processor is configured to assign each device an absolute pose within the coordinate space. Such an approach enables accurate localization of the plurality of devices without relying on external positioning systems, facilitating applications such as autonomous navigation, spatial tracking, and real-time localization in dynamic environments.

In an example, consider a system comprising three devices, device A, device B, and device C, each device equipped with at least one audio sensor. Said three devices may be placed within an environment where a speed of sound is known (e.g., 343 metres/sec in air at room temperature). In this regard, an acoustic event, such as a clap sound or an ultrasonic beacon pulse may occur at a specific location within the environment. The acoustic event emits a sound signal that propagates through the environment, reaching the at least one audio sensor at different times due to their spatial separation. The processor using device A as a reference, may record timestamps at which the at least one audio sensor arranged on each device detects the sound signals, i.e.,
an audio sensor arranged on a device A may detect a sound signal at timestamp T₁=0.0020 seconds,
an audio sensor arranged on a device B may detect a sound signal at timestamp T₂=0.0024 seconds, an audio sensor arranged on a device C may detect a sound signal at timestamp T₃=0.0026 seconds. In this regard, the processor may compute the TDoA values relative to device A, i.e.,

$$TDoA ( B , A ) = {T}_{2} - {T}_{1} = 0.0024 - 0.002 = 0.0004 seconds ,$$

$$TDoA ( C , A ) = {T}_{3} - {T}_{1} = 0.0026 - 0.002 = 0.0006 seconds .$$

Using the known speed of sound 343 metres/second (m/s), the processor may convert the time differences into distance differences, i.e.,

$$Distance Difference ( B , A ) = 343 m / s \times 0.0004 s = 0.1372 meters ,$$

$$Distance Difference ( C , A ) = 343 m / s \times 0.0006 s = 0.2058 meters .$$

Thus, the processor may determine that device B may be positioned 13.72 centimetres (cm) farther from device A in a specific direction, device C may be positioned 20.58 cm farther from device A in another direction. The processor may construct a relative positioning map of said devices using these inter-device distances. Herein, the processor may integrate the estimated relative poses with the known pose of the sound source in the coordinate space. In this case, if the sound source may be located at (0, 0, 0) within the coordinate space, the processor may use the triangulation technique or the multilateration technique to determine the poses of the device A, the device B, and the device C. Based on said techniques, the processor may determine that device A may be at (3.5, 2.0, 1.2) metres, device B may be at (7.8, 5.4, 2.1) metres, and device C may be at (1.9, 3.0, 2.0) metres. Thus, the processor determines the poses of the plurality of devices within the coordinate space, wherein said pose values can be used for further localization, mapping, navigation applications, and similar. Moreover, if the one or more acoustic events are detected over time, the processor continuously refines the relative poses, enabling real-time tracking of the plurality of devices.

Optionally, at least two audio sensors are attached with each device amongst the plurality of devices, and wherein the processor is further configured to estimate an orientation of any device amongst the plurality of devices, based on time differences of arrival (TDoA) of detected sound signals by at the at least two audio sensors. In this regard, the term “orientation” refers to an angular position or a rotational alignment of a given device amongst the plurality of devices in the coordinate space relative to a reference frame. The orientation specifies how the given device is positioned in terms of a pitch, a yaw, and a roll angle or other rotational parameters that describe its directional alignment. Herein, the processor estimates the orientation of any device among the plurality of devices by analysing the TDoA of detected sound signals at the at least two audio sensors attached to the device. When the sound signals propagates through the environment and reaches any device amongst the plurality of devices, said sound signals are detected at slightly different times by each audio sensor due to their spatial separation. The processor records these time differences and based on the known speed of sound and fixed distance between the two audio sensors, said processor may determine relative direction from which the sound signals originated with respect to said device. By continuously analysing multiple sound signals, the processor refines the orientation estimate over time. A technical effect of the aforementioned feature is that such an approach enables real-time tracking of the orientation of any device amongst the plurality of devices without requiring additional sensors, allowing for efficient and accurate orientation estimation in dynamic environments.

Optionally, the system further comprising the at least one source of the sound signals, wherein the at least one source comprises at least one of:
an ultrasonic beacon, a speaker, a movable object whose movement generates a sound, a user wearing a given device produces sound; and
wherein the processor is configured to determine at least one of: a location of the at least one source, a distance of the at least one source based on the sound signals captured by the at least one audio sensor.

In this regard, the system further comprises the at least one source of sound signals, which may be an active emitter (e.g., an ultrasonic beacon, a speaker, and similar), a passive emitter (e.g., a moving object generating sound naturally, and the like). Herein, if the at least one source may be the ultrasonic beacon, the speaker, it may periodically emit predefined signals. Optionally, if the at least one source may be the moving object, a sound signal may be generated through motion-induced noise, such as footsteps or mechanical vibrations. Optionally, if the at least one source may be the user wearing the given device that produces sound, i.e., a user wearing the HMD device produces sound, for example, such as a speech of said user. In an implementation, using the sound signals captured by the at least one audio sensor, the processor is configured to determine at least one of: the location of the at least one source, the distance of the at least one source by performing signal processing and spatial computation techniques. Herein, the processor first detects arrival time of the sound signals at each audio sensor and extracts relevant timing information, such as the TDoA between different audio sensors. If the absolute transmission time of the sound signals from the at least one source is known, the processor may calculate the distance of the at least one source based on time delay and the known speed of the sound in the environment. Optionally, if the at least one audio sensor detects the sound signals, the processor determines relative time differences and applies the triangulation technique or the multilateration technique to estimate the location of the at least one source within the coordinate space. When the at least one source of the sound signals emits sound signals periodically or moves within the environment, the processor refines location estimates over time by integrating multiple measurements. Additionally, if the at least one source of the sound signals may be associated with a known device, the processor may retrieve stored position information to enhance localization accuracy. It will be appreciated that by incorporating both active sound sources and passive sound sources, including user-generated sounds, the system ensures robust adaptability to various acoustic environments, thereby reducing reliance on predefined signal patterns. A technical effect of the aforementioned feature is that the system enables real-time localization of sound-emitting sources without relying on external positioning systems, enhancing spatial awareness in dynamic environments.

Optionally, the system further comprising a temperature sensor configured to measure ambient temperature of the environment, and wherein the processor is configured to calibrate the speed of sound in the environment based on the measured ambient temperature. In this regard, the term “temperature sensor” refers to a sensor configured to measure the ambient temperature of the environment by detecting thermal energy and converting it into an electrical signal. The temperature sensor may operate based on various principles, including resistance variation (e.g., thermistors, resistance temperature detectors, and the like), voltage generation (e.g., thermocouples, and the like), infrared radiation detection (e.g., infrared temperature sensors, and the like). The measured temperature data may be processed by the processor to enable temperature-dependent calibrations, compensations, or control functions within the system. Examples of the temperature sensor may include, but are not limited to, a thermistor, a resistance temperature detector (RTD), a thermocouple, an infrared temperature sensor, a semiconductor-based temperature sensor, and a digital temperature sensor. Moreover, the term “ambient temperature” refers to a temperature of surrounding environment in which the system operates.

The ambient temperature represents the temperature of an air or a medium surrounding the system, unaffected by any localized heat sources or cooling mechanisms. The ambient temperature is an essential parameter in various applications, including sensor calibration, thermal management, and environmental monitoring, as it directly influences material properties, signal propagation characteristics, and overall performance of the system.

Herein, the processor is configured to calibrate the speed of sound in the environment based on measured ambient temperature by utilizing known physical relationships between temperature and propagation velocity of sound waves in a given medium. In an air-filled environment, a speed of sound (c) varies as a function of temperature (T) according to an empirical equation (1);

$$C = {C}_{0} \sqrt{\frac{T}{{T}_{0}}} \qquad ( 1 )$$

wherein, c₀ is a reference speed of sound at a standard temperature (e.g., 343 m/s at 20° C. in dry air,
T is the measured ambient temperature in Kelvin,
T₀ is the reference temperature in Kelvin (e.g., 293.15 Kelvin for 20 degrees Celsius).

Optionally, the processor being communicably coupled to the temperature sensor, receives real-time ambient temperature data from the temperature sensor and computes an updated value of the speed of the sound using the equation (1). If the environment has varying temperature conditions, the processor may continuously adjust the speed of sound to reflect these changes, ensuring more accurate distance and position estimations. In this regard, the calibrated speed of sound is then used in various computational processes, such as time of arrival calculations, TDoA measurements, localization and tracking algorithms, and similar. By dynamically calibrating the speed of sound, the processor ensures that distance and position calculations remain accurate across different environmental conditions, thereby reducing measurement errors caused by temperature fluctuations.

A technical effect of the aforementioned feature is that the system maintains high localization accuracy under varying environmental conditions by dynamically calibrating the speed of sound in the environment. Such an approach improves robustness and adaptability of sound-based positioning methods, thereby reducing errors that could arise due to temperature fluctuations.

Optionally, the processor is further configured to determine a direction of arrival (DOA) of the sound signals per audio sensor, based on the timestamps in the sensor data and a geometric arrangement of at least two audio sensors within each of the plurality of devices, wherein the processor determines the poses of the plurality of devices in the coordinate space of the environment, based also on the direction of arrival of the sound signals per audio sensor.

In this regard, the phrase “direction of arrival of the sound signals” refers to an angular direction from which an incoming sound wave propagates towards the at least one audio sensor. The direction of arrival (DOA) of the sound signals per audio sensor may be determined by analysing time differences, phase differences, amplitude variations, and similar. The DOA estimation enables the localization of sound sources and is used in applications such as beamforming, spatial audio processing, and tracking of the plurality of devices. Moreover, the term “geometric arrangement” refers to a placement, an orientation, and a distance between the at least two audio sensors arranged on the at least one device amongst the plurality of devices.

Herein, the processor extracts timestamps from the sensor data corresponding to the sound signals detected at each audio sensor. Given the known geometric arrangement of the at least two audio sensors within each device, the processor computes TDoA between these audio sensors. Using the TDoA, the processor may apply a beamformer algorithm or phase-difference-based calculations to estimate the DOA of the sound signals. Herein, the term “beamformer algorithm” refers to a signal processing technique that utilizes an array of audio sensors to selectively focus a sound signal coming from a specific direction by adjusting a phase and an amplitude of each audio sensor's output, effectively enhancing a desired sound signal while suppressing interference from other directions. The beamformer algorithm processes the sound signals from multiple spatially distributed audio sensors to filter, amplify, or spatially separate sound sources based on their direction of arrival. Once the processor determines the DOA of the sound signals, it uses this information to estimate the poses of the plurality of devices in the coordinate space of the environment. In this regard, the processor combines the DOA values with localization techniques such as the triangulation technique or the multilateration technique to determine the position of each device in the environment. If multiple known sound sources are present, their relative DOAs across different devices further enhance localization accuracy. The DOA values provide information on how each device is oriented relative to the detected sound sources. By analysing the DOA measurements across multiple sound signals and the at least one source of the sound signals, the processor determines an angular orientation of each device. As new sound signals are detected, the processor continuously updates estimation of the position and orientation of the plurality of devices. It will be appreciated that determining the DOA of the sound signals enables accurate estimation of the poses of the plurality of devices without relying on additional external tracking infrastructure, thereby enhancing self-localization capabilities in dynamic environments. It will also be appreciated that by continuously updating position and orientation estimates based on new sound signals, the system provides real-time spatial awareness, which is beneficial for applications requiring dynamic tracking, such as multi-user AR interactions, autonomous drone navigation, hands-free user interfaces, and similar.

A technical effect of the aforementioned feature is that the system enhances spatial localization accuracy by incorporating calculation based on the DOA of the sound signals per audio sensor, thereby enabling precise determination of both the position and orientation of the plurality of devices within the environment.

In an embodiment, the processor is further configured to determine a distance between any two devices amongst the plurality of devices, based on the direction of arrival of the sound signals per audio sensor of the two devices and time differences of arrival (TDoA) of detected sound signals by the at least one audio sensor of each of the two devices, when the at least one source of the sound signals lies outside of an area enclosed by the plurality of devices. In this regard, the processor may first identify that a common external sound source (i.e., a sound source located outside the enclosed area) has been detected by the at least one audio sensor in each of the two devices amongst the plurality of devices. Since the at least one source of the sound signal is external, it provides a reference point for both devices. Specifically, when the at least one source of the sound signal is located outside the area enclosed by the plurality of devices, the processor processes the sensor data received from each audio sensor to determine the DOA of the sound signals relative to a common coordinate space. In this regard, the processor is configured to retrieve the DOA values for both devices, which may provide bearing angles of the incoming sound signal with respect to each device's known orientation. Herein, the term “bearing angle” refers to an angle between a reference direction and a direction of an incoming sound signal. These angles describe relative directions from which the sound signals arrives at each device. Simultaneously, the processor calculates the TDoA between the audio sensors of each of the two devices. The processor utilizes the TDoA values to estimate the difference in travel time of the sound signals between the two devices. Given that sound travels at a known speed, the TDoA provides an estimate of an extra distance the sound signals travelled to reach one device before the other. This extra distance acts as a constraint for determining spatial separation between the two devices. With the DOA values providing the bearing angles and the TDoA values constraining the distance difference, the processor uses both the DOA values and the TDoA values to compute the distance between any two devices amongst the plurality of devices.

It will be appreciated that combining the DOA and the TDoA provides redundancy and error correction, allowing the system to maintain precise distance estimates even when certain audio sensors experience temporary signal loss or environmental noise. It will also be appreciated that leveraging the external sound source as a reference allows for passive localization, reducing the need for active signal transmission and thereby minimizing power consumption in resource-constrained devices. A technical effect of the aforementioned feature is that the system enables accurate estimation of the distance between any two devices without requiring additional ranging hardware, thereby facilitating precise localization in various environments.

In another embodiment, the processor is further configured to calculate a distance between any two devices amongst the plurality of devices, based on a triangulation technique, when the at least one source of the sound signals lies within an area enclosed by the plurality of devices. In this regard, the term “triangulation technique” refers to a geometric method used to determine a position or a distance between any two devices amongst the plurality of devices by measuring angles and applying trigonometric principles. By forming a triangle with known or measurable angles and using mathematical relationships such as law of sines or law of cosines, the processor can accurately determine the distance between any two devices amongst the plurality of devices. Herein, when the at least one source of the sound signals lies within the area enclosed by the plurality of devices, the processor does not rely on DOA angles. Instead, the processor utilizes the spatial relationship between any two devices and their detection of the common sound source to compute inter-device distances. The processor may first detect that a sound signal originates from within the enclosed area. The plurality of devices receive the sound signals at different times based on their positions relative to the at least one source. Each device registers a time at which it receives the sound signal, the processor determines the TDoA between multiple device pairs. Since the speed of sound is known, TDoA values help to estimate relative distances. The processor selects two devices and retrieves their respective TDoA values concerning the common sound source. Using the known positions of the two devices, the processor is configured to apply the triangulation technique (such as the law of sines or the law of cosines) to compute the distance between them. Since the sound source is inside the enclosed area, multiple devices detect it from different positions, allowing the processor to resolve inter-device distances without relying on the DOA. In some cases, if additional sound signals are detected over time, the processor is configured to refine the computed distances, ensuring dynamic updates to relative positions of any two devices amongst the plurality of devices. It will be appreciated that such an approach enables robust distance measurements even in environments where estimation of the direction of arrival may be unreliable due to multipath interference or signal obstructions.

A technical effect of calculating the distance between any two devices amongst the plurality of devices, based on the triangulation technique, is that accurate inter-device distance measurements can be achieved using known spatial relationships and sound signal timing, without requiring direction of arrival data, thereby enabling precise localization in enclosed environments.

In yet another embodiment, the processor is further configured to calculate a distance between any two devices amongst the plurality of devices based on the determined poses of the two devices within the coordinate space. In this regard, a pose of a given device amongst the plurality of devices includes spatial coordinates (i.e., x, y, z) and orientation angles (i.e., a pitch, a yaw, a roll) within the coordinate space. It is to be understood that the processor has determined the poses of two devices amongst the plurality of devices. Herein, the processor has calculated three-dimensional (3D) coordinates of said two devices amongst the plurality of devices. Once calculated, the processor may apply Euclidean distance formula to compute the distance between said two devices amongst the plurality of devices, which may be given by an equation (2);

$$d = \sqrt{{( {x}_{2} - {x}_{1} )}^{2} + {( {y}_{2} - {y}_{1} )}^{2} + {( {z}_{2} - {z}_{1} )}^{2}} \qquad ( 2 )$$

wherein, d represents distance between any two devices amongst the plurality of devices within the coordinate space,
x1, y1, z1 and x2, y2, z2 may represent spatial coordinates of said two devices, respectively, within the coordinate space.

In an example, consider two devices, such as device A and device B amongst the plurality of devices may be operating within the coordinate space of the environment. Herein, determined pose of device A and determined pose of device B may be given by equations (3) and (4), respectively;

$$( x 1 , y 1 , z 1 ) = ( 3.5 m , 2. m , 1.2 m ) \qquad ( 3 )$$

$$( x 2 , y 2 , z 2 ) = ( 7.8 m , 5.4 m , 2.1 m ) \qquad ( 4 )$$

wherein, x1, y1, z1 may represent spatial coordinates of device A within the coordinate space, and x2, y2, z2 may represent spatial coordinates of device B within the coordinate space. These positions are expressed in metres within the coordinate space. Once, the processor may receive the aforesaid determined poses of device A and device B, said processor may substitute determined pose values in equation (2),

$$d = \sqrt{{( 7.8 - 3.5 )}^{2} + {( 5.4 - 2. )}^{2} + {( 2.1 - 1.2 )}^{2}}$$

$$d = \sqrt{{( 4.3 )}^{2} + {( 3.4 )}^{2} + {( 0.9 )}^{2}}$$

$$d = \sqrt{30 \cdot 86}$$

$$d = 5.55 metres$$

Thus, the distance between the device A and device B may be 5.55 metres based on the determined poses of said two devices.

A technical effect of the aforementioned feature is that it enables a highly accurate and computationally efficient method of measuring inter-device distances without relying on external signals, thereby reducing errors caused by environmental interference. It will be appreciated that such an approach ensures real-time spatial awareness, making it suitable for applications requiring precise localization, such as robotics, AR, and collaborative sensing systems. It will also be appreciated that using pose-based distance calculation eliminates need for additional sensor measurements, optimizing system performance and reducing hardware complexity while ensuring continuous and reliable distance computation.

Optionally, the processor is further configured to combine a data of the determined poses with a data from an inertial measurement unit (IMU). In this regard, the data of the determined poses refers to an information representing absolute or relative spatial positions and orientations of the plurality of devices within the coordinate space. This data may include parameters such as position coordinates, orientation angles, timestamps indicating when each pose was determined, and similar. Moreover, the term “inertial measurement unit” refers to an electronic device that measures and reports specific force, an angular velocity, and sometimes orientation of an object using a combination of sensors, typically including accelerometers, gyroscopes, and optionally magnetometers. The inertial measurement unit (IMU) provides motion and orientation data relative to an inertial reference frame, enabling precise tracking of movement, rotation, and acceleration. IMUs are commonly used in navigation, motion tracking, and stabilization applications, where external positioning references may be limited or unavailable. In an implementation, the IMU may be placed within the coordinate space of the environment and optionally, said IMU is communicably coupled to the processor. Herein, the processor continuously collects and processes pose data, which represents the absolute position of the plurality of devices within the coordinate space. Simultaneously, the processor receives real-time IMU data, which may include motion dynamics such as an acceleration, an angular velocity, an orientation changes, and similar. In this regard, the processor may apply sensor fusion techniques for example, such as Kalman filtering, complementary filtering, and the like, to integrate both datasets. Such an integration allows the system to refine pose estimations by correcting drifts, minimizing inconsistencies, and ensuring a continuous and accurate tracking of movement of the plurality of devices over time. A technical effect of combining data from determined poses with the data from the IMU is that the system achieves enhanced spatial accuracy and stability in tracking movement of the plurality of devices, even in environments with signal obstructions or dynamic changes. It will be appreciated that such an integration reduces drift errors commonly associated with standalone IMU data and refines positional estimates obtained from external sensing methods, leading to improved navigation, object tracking, and spatial coordination amongst the plurality of devices.

Optionally, the processor is further configured to combine a data of the determined poses with a data from visual camera. In this regard, the data from visual camera refers to an image-based information captured by the visual camera within the environment. This data may include raw image frames, detected features (such as edges, corners, landmarks, and similar), depth information, motion patterns extracted through image processing techniques, and similar. The visual camera data provides spatial references that can be used for object recognition, environmental mapping, motion tracking, and similar. In an implementation, the visual camera may be placed within the coordinate space of the environment, and optionally, said visual camera is communicably coupled to the processor.

Herein, the processor receives the pose data, which represents the absolute position of the plurality of devices within the coordinate space. Simultaneously, the processor processes real-time visual data from the visual camera, such as object features, landmarks, or relative positions of the plurality of devices within captured images. In this regard, the processor may apply sensor fusion techniques, such as visual-inertial odometry (VIO), visual simultaneous localization and mapping (vSLAM), and similar, to combine both data sources. By aligning visual features with the pose data, the processor corrects positional errors, enhances tracking stability, and ensures that device movements are accurately represented within the coordinate space of the environment. A technical effect of combining the data from determined poses with the data from the visual camera is that the system achieves improved spatial accuracy and robustness in tracking the plurality of devices. This integration allows for enhanced environmental awareness, reducing errors associated with standalone pose estimation methods. It will be appreciated that such a fusion enables real-time adjustments in device positioning, ensuring stable and precise movement tracking, even in environments with dynamic obstructions or low sensor reliability.

Optionally, the processor is further configured to time-synchronize the plurality of devices using a shared time reference. In this regard, the term “time-synchronize” refers to a process of aligning an internal clocks of the plurality of devices within the system to a common time standard, ensuring that all devices operate based on a consistent temporal framework. The time synchronization allows for precise coordination of data acquisition, processing, and communication across the plurality of devices, minimizing timing discrepancies. Moreover, the term “shared time reference” refers to a common temporal standard or a time source that is used to synchronize clocks of the plurality of devices within the system. The shared time reference provides a unified time framework that all devices adhere to, ensuring consistency in timestamped data, event sequencing, and coordinated operations.

Herein, the processor achieves the time synchronization by utilizing the shared time reference. This reference may be established through various synchronization techniques, for example, such as Network Time Protocol (NTP) or Precision Time Protocol (PTP) (i.e., synchronizing devices over a network using standardized time protocols), Global Positioning System (GPS) based synchronization, timestamp alignment via wireless communication (i.e., broadcasting periodic time signals or timestamps over a communication channel to synchronize the internal clocks of all devices), and similar. It will be appreciated that the shared time reference is essential for ensuring consistency in comparing timestamps of the detected sound signals across the plurality of devices. If a sound signal reaches two devices at slightly different times due to spatial separation, the shared time reference ensures that the timestamps recorded by both devices are aligned to a common clock. This synchronization allows the system to accurately calculate the time difference between arrival of the sound signals, which is essential for determining parameters such as a sound source localization, relative positioning, and other time-dependent measurements.

A technical effect of time-synchronizing the plurality of devices using the shared time reference is that it enables precise and consistent data alignment across the plurality of devices. This synchronization reduces timing errors in sensor fusion, enhances spatial and temporal accuracy in pose estimation, and ensures coherent event detection and coordination. Additionally, it facilitates seamless integration of data from multiple sources, improving reliability of tracking the plurality of devices, communication, and collaborative decision-making. By minimizing discrepancies in time-sensitive operations, the system achieves enhanced performance, robustness, and real-time responsiveness, particularly in applications involving motion tracking, environmental mapping, and multi-sensor fusion.

The present disclosure also relates to the second aspect as described above. Various embodiments and variants disclosed above, with respect to the aforementioned first aspect, apply mutatis mutandis to the second aspect.

Optionally, the method further comprising:
measuring ambient temperature of the environment using a temperature sensor; and
calibrating the speed of sound in the environment based on the measured ambient temperature.

Optionally, the method further comprising determining a direction of arrival (DOA) of the sound signals per audio sensor, based on timestamps in the sensor data and a geometric arrangement of the at least two audio sensors within each of the plurality of devices, wherein the step of determining the poses of the plurality of devices in the coordinate space of the environment is performed based also on the direction of arrival of the sound signals per audio sensor.

### DETAILED DESCRIPTION OF THE DRAWINGS

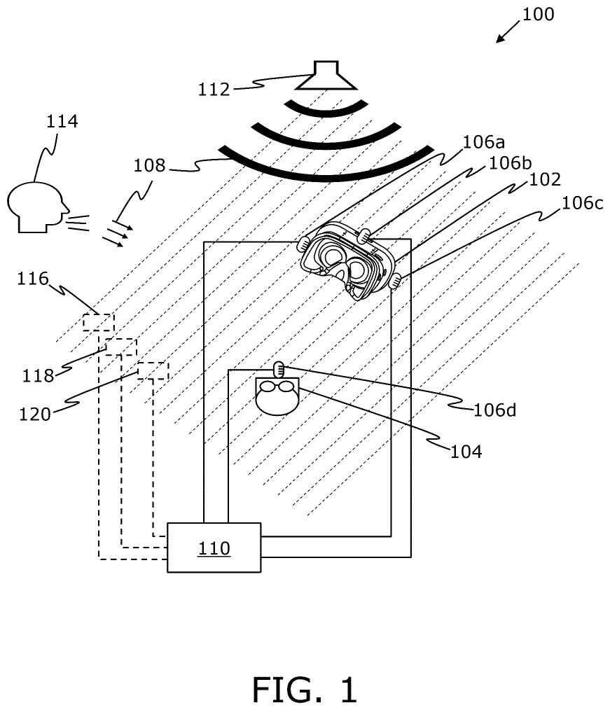

Referring to FIG. 1, illustrated is an exemplary schematic illustration of an environment 100 where a system for tracking poses of a plurality of devices (for example, depicted as devices 102 and 104) is used, in accordance with an embodiment of the present disclosure.

As shown, a plurality of audio sensors (for example, depicted as audio sensors 106a, 106b, 106c, and 106d), wherein at least one audio sensor is attached with each device amongst said devices 102 and 104 (for example, for the sake of clarity, three audio sensors 106a-c are attached with a device 102 and one audio sensor 106d is attached with a device 104). Herein, each audio sensor 106a-d is configured to detect sound signals 108 incident thereon and generate sensor data including timestamps corresponding to the detected sound signals. As shown, a processor 110 is communicatively coupled to the audio sensors 106a-d, wherein the processor 110 is configured to receive the sensor data from the audio sensors 106a-d, identify one or more acoustic events based on correlations of the detected sound signals across the sensor data. Next, the processor 110 estimates relative poses of the devices 102 and 104 based on time differences of arrival (TDoA) of the sound signals 108 corresponding to a same acoustic event and a speed of sound in the environment 100. Then, the processor 110 determines poses of the devices 102 and 104 within a coordinate space of the environment 100, based on the estimated relative poses of said devices 102 and 104, the speed of sound, and a pose of at least one source of the sound signals 108 in the coordinate space. Optionally, there is shown that the at least one source of the sound signals 108 comprises at least one of: an ultrasonic beacon 112, a sound signal 108 produced by a given user 114. Optionally, the system further comprises a temperature sensor 116 configured to measure ambient temperature of the environment 100, and wherein the processor 110 is configured to calibrate the speed of sound in the environment 100 based on the measured ambient temperature. Optionally, the system further comprises an inertial measurement unit (IMU) 118, wherein the processor 110 is further configured to combine a data of the determined poses with a data from the IMU 118. Optionally, the system further comprises a visual camera 120, wherein the processor 110 is further configured to combine a data of the determined poses with a data from the visual camera 120. Optionally, the processor 110 is communicably coupled to the temperature sensor 116, the IMU 118, and the visual camera 120.

FIG. 1 is merely an example, which should not unduly limit the scope of the claims herein. A person skilled in the art will recognize many variations, alternatives, and modifications of embodiments of the present disclosure.

Referring to FIG. 2, illustrated is a block diagram of a system 200 for tracking poses of a plurality of devices (for example, depicted as devices 202, 204, and 206) within an environment, in accordance with an embodiment of the present disclosure. Herein, the system 200 comprises a plurality of audio sensors (depicted as audio sensors 208a, 208b and 208c) and a processor 210 communicatively coupled to the audio sensors 208a-c. Herein, at least one audio sensor is attached with each device (for example, audio sensor 208a is attached with device 202, audio sensor 208b is attached with device 204, and audio sensor 208c is attached with device 206) amongst the devices 202, 204, and 206. Herein, each audio sensor 208a-c is configured to detect sound signals incident thereon and generate sensor data including timestamps corresponding to the detected sound signals. The processor 210 is configured to perform various processing operations, as described earlier with respect to the aforementioned first aspect. Optionally, the system 200 further comprises a temperature sensor 212 configured to measure ambient temperature of the environment, an inertial measurement unit (IMU) 214, a visual camera 216. Optionally, the processor 210 is communicably coupled to the temperature sensor 212, the IMU 214, and the visual camera 216.

It may be understood by a person skilled in the art that the FIG. 2 includes a simplified architecture of a system 200 for sake of clarity, which should not unduly limit the scope of the claims herein. The person skilled in the art will recognize many variations, alternatives, and modifications of embodiments of the present disclosure.

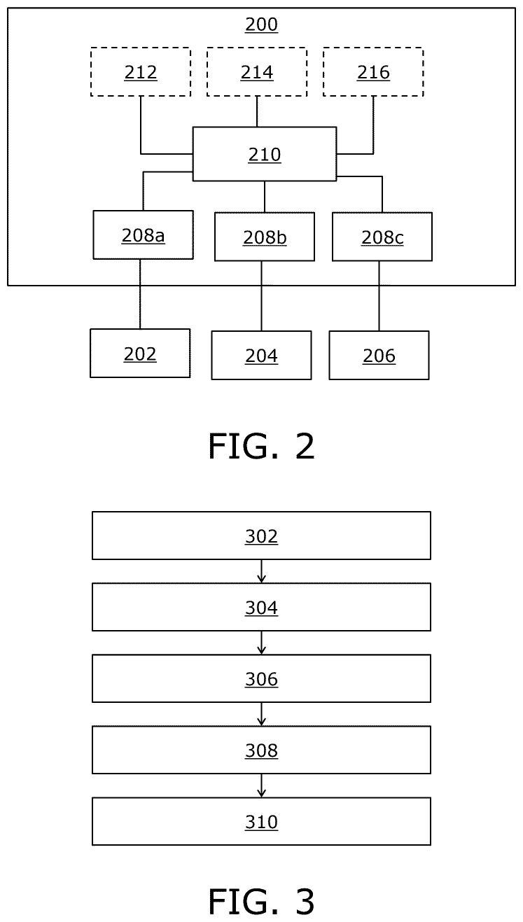

Referring to FIG. 3, illustrated are steps of a method for tracking poses of a plurality of devices within an environment, in accordance with an embodiment of the present disclosure. At step 302, sound signals incident on a plurality of audio sensors are detected and sensor data including timestamps is generated corresponding to the detected sound signals, wherein at least one audio sensor is attached with each device amongst the plurality of devices. At step 304, the sensor data is received from the plurality of audio sensors. At step 306, one or more acoustic events are identified based on correlations of detected sound signals across the sensor data. At step 308, relative poses of the plurality of devices are estimated based on time differences of arrival (TDoA) of the sound signals corresponding to a same acoustic event and a speed of sound in the environment. At step 310, poses of the plurality of devices are determined within a coordinate space of the environment, based on the estimated relative poses of the plurality of devices, the speed of sound, and a pose of at least one source of the sound signals in the coordinate space.

The aforementioned steps are only illustrative and other alternatives can also be provided where one or more steps are added, one or more steps are removed, or one or more steps are provided in a different sequence without departing from the scope of the claims herein.

1. A system for tracking poses of a plurality of devices within an environment, the system comprising:
a plurality of audio sensors, wherein at least one audio sensor is attached with each device amongst the plurality of devices, wherein each audio sensor is configured to:
detect sound signals incident thereon; and
generate sensor data including timestamps corresponding to the detected sound signals; and
a processor communicatively coupled to the plurality of audio sensors, wherein the processor is configured to:
receive the sensor data from the plurality of audio sensors;
identify one or more acoustic events based on correlations of the detected sound signals across the sensor data;
estimate relative poses of the plurality of devices based on time differences of arrival (TDoA) of the sound signals corresponding to a same acoustic event and a speed of sound in the environment; and
determine poses of the plurality of devices within a coordinate space of the environment, based on the estimated relative poses of the plurality of devices, the speed of sound, and a pose of at least one source of the sound signals in the coordinate space.

2. The system according to claim 1, further comprising a temperature sensor configured to measure ambient temperature of the environment, and wherein the processor is configured to calibrate the speed of sound in the environment based on the measured ambient temperature.

3. The system according to claim 1, wherein the processor is further configured to determine a direction of arrival (DOA) of the sound signals per audio sensor, based on the timestamps in the sensor data and a geometric arrangement of at least two audio sensors within each of the plurality of devices,
wherein the processor determines the poses of the plurality of devices in the coordinate space of the environment, based also on the direction of arrival of the sound signals per audio sensor.

4. The system according to claim 3, wherein the processor is further configured to determine a distance between any two devices amongst the plurality of devices, based on the direction of arrival of the sound signals per audio sensor of the two devices and time differences of arrival (TDoA) of detected sound signals by the at least one audio sensor of each of the two devices, when the at least one source of the sound signals lies outside of an area enclosed by the plurality of devices.

5. The system according to claim 1, wherein the processor is further configured to calculate a distance between any two devices amongst the plurality of devices, based on a triangulation technique, when the at least one source of the sound signals lies within an area enclosed by the plurality of devices.

6. The system according to claim 1, wherein the processor is further configured to calculate a distance between any two devices amongst the plurality of devices, based on the determined poses of the two devices within the coordinate space.

7. The system according to claim 1, wherein at least two audio sensors are attached with each device amongst the plurality of devices, and wherein the processor is further configured to estimate an orientation of any device amongst the plurality of devices, based on time differences of arrival of detected sound signals by at the at least two audio sensors.

8. The system according to claim 1, wherein the processor is further configured to combine a data of the determined poses with a data from an inertial measurement unit (IMU).

9. The system according to claim 1, wherein the processor is further configured to combine a data of the determined poses with a data from a visual camera.

10. The system according to claim 1, further comprising the at least one source of the sound signals, wherein the at least one source comprises at least one of: an ultrasonic beacon, a speaker, a movable object whose movement generates a sound, a user wearing a given device produces sound; and
wherein the processor is configured to determine at least one of: a location of the at least one source, a distance of the at least one source based on the sound signals captured by the at least one audio sensor.

11. The system according to claim 1, wherein a given audio sensor is configured to detect ultrasonic signals emitted by an ultrasonic beacon operating at predefined intervals.

12. The system according to claim 1, wherein the processor is further configured to time-synchronize the plurality of devices using a shared time reference.

13. The system according to claim 1, wherein the plurality of devices comprise at least two of: a head-mounted display device, a user-interaction controller, a tracking puck, a wearable device.

14. The system according to claim 1, wherein a given audio sensor is selected from at least one of: a microphone array, an acoustic camera.

15. A method for tracking poses of a plurality of devices within an environment, the method comprising:
detecting sound signals incident on a plurality of audio sensors and generating sensor data including timestamps corresponding to the detected sound signals, wherein at least one audio sensor is attached with each device amongst the plurality of devices;
receiving the sensor data from the plurality of audio sensors;
identifying one or more acoustic events based on correlations of detected sound signals across the sensor data;
estimating relative poses of the plurality of devices based on time differences of arrival (TDoA) of the sound signals corresponding to a same acoustic event and a speed of sound in the environment; and
determining poses of the plurality of devices within a coordinate space of the environment, based on the estimated relative poses of the plurality of devices, the speed of sound, and a pose of at least one source of the sound signals in the coordinate space.

16. The method of claim 15, further comprising:
measuring ambient temperature of the environment using a temperature sensor; and
calibrating the speed of sound in the environment based on the measured ambient temperature.

17. The method of claim 15, further comprising determining a direction of arrival (DOA) of the sound signals per audio sensor, based on timestamps in the sensor data and a geometric arrangement of the at least two audio sensors within each of the plurality of devices,
wherein the step of determining the poses of the plurality of devices in the coordinate space of the environment is performed based also on the direction of arrival of the sound signals per audio sensor.
